(19) United States
(12) Patent Application Publication
(10) Pub. No.: US 2018/0202142 A1
(43) Pub. Date: Jul. 19, 2018

(54) TANK ASSEMBLY MADE OF PLASTICS AND TANK TRUCK WITH SUCH A TANK ASSEMBLY

(71) Applicant: Alessio DAINELLI, Poggibonsi (SI) (IT)

(72) Inventor: Alessio DAINELLI, Poggibonsi (SI) (IT)

(73) Assignee: Blackstar Worldwide, LLC, Atlanta, GA (US)

(21) Appl. No.: 15/741,987

(22) PCT Filed: Jul. 7, 2016
(86) PCT No.: PCT/IB2016/054072

§ 371 Date: Jan. 4, 2018

(30) Foreign Application Priority Data
Jul. 13, 2015 (IT) 102015000033602

(51) Int. Cl. E03F 7/10; B60P 3/22; B65D 90/02; B65D 88/54

(52) U.S. Cl. CPC E03F 7/10; B60P 3/2205; E04H 1/1216; B65D 88/54; B60P 3/2245; B65D 90/02

(57) ABSTRACT

A tank assembly (1) is mountable on a tank truck for the collection of waste material from a portable chemical toilet and for the maintenance thereof includes an outer rigid housing (10) and an inner tank (14) enclosed in the housing (10) and provided with waste material loading nozzles (18, 19) and waste material discharge nozzles (17). The outer housing (10) includes an inner wall (31, 32) having a surface which is complementary and substantially mating and closely contacting the surface of the inner tank (14). The outer housing (10) and the inner tank (14) are made of plastic material. The inner tank (14) has a substantially spherical shape. The tank assembly (1) is light-weight, of low production cost and does not have corrosion problems.

### FIELD OF THE INVENTION

The present invention relates to the field of waste material collection, in particular human waste collection. More particularly, the invention relates to a tank assembly for collecting waste material from portable chemical toilets and for the periodic maintenance of said portable chemical toilets. More precisely, the invention relates to a tank assembly intended for being mounted on a loading bed of a tanker truck.

### Background of the Invention

As is known, a chemical toilet is a sanitary appliance in which a chemical agent is used for bowl sanitising after each use. The chemical toilet finds application in all the circumstances where a sewer system is not available for discharging bodily wastes, which, instead, are collected in a reservoir the toilet is equipped with. Thus, chemical toilets are widely used on trains, planes, camping cars, caravans and the like. In these cases the reservoir may be fixed to the toilet structure or removably associated therewith for emptying purpose. See for example EP1118505, DE4003555 and U S2005/0283893.

Another very common use of a chemical toilet is in construction sites as well as in events, shows and outdoor entertainments and the like, and in this case the chemical toilet consist of a cabin, which is portable and arranged for temporary installation, in which the bowl and the waste material collection reservoir, the reservoir for the sanitising chemical agent, and possibly an hand basin, an urinal, and a clean water reservoir are provided together with any other supplementary device that may be necessary for its use or dictated by local regulations and/or use standards. A portable chemical toilet for the above application is disclosed in, for example, EP 918112.

In the case of portable chemical toilets a service of periodical reservoir emptying and periodical cleaning/maintenance is generally ensured. This service is performed by way of tanker trucks or equipped trucks, provided with a tank for collecting wastes, together with a waste suction system from the portable chemical toilet reservoir and a waste discharge system at a treatment/disposal plant, sanitising and hygienising liquids (chemicals, detergents, water and any other equipment necessary for the maintenance of the mobile chemical bath). Room may also be provided on the loading bed of such tanker truck for transporting a cabin intended to replace or withdraw a cabin in need thereof or for a new installation.

Medium-duty trucks are used for the above mentioned application, whereby the useful transport space must be optimised between the volume occupied by the tank, the space necessary for the accessory equipment and that for the possible spare cabin.

Conventional tanks used for the above mentioned use and for related uses are generally cylindrical hollow bodies made of metallic material configured for being mounted on vehicles such as trucks and secured to the loading bed thereof. The tank must withstand a certain degree of inner vacuum to allow the waste material to be sucked from the reservoir of the portable chemical toilet and furthermore it can withstand the inner pressure due to the waste material once filled therein. The volume of such tanks is, for example, about 1000-2000 litres, on average.

Since the currently used tanks are made of metallic material, they are subject to corrosion and wear mainly at the welded connections. The cost of the tank is relatively high due to both the manufacturing process, which includes careful weldings, and the need to conduct vacuum and pressure leak tests. The tanks thus require constant maintenance to limit corrosion damages and in any case their duration is limited.

Furthermore, such prior art tanks have a relatively high weight which significantly affect the total, full load weight of the truck.

Thus the need exists for an apparatus for the collection of the wastes from portable chemical toilets and the periodical maintenance thereof wherein the collection tank would not have corrosion problems, while ensuring the required mechanical resistance both when operating under vacuum conditions and under the effect of the pressure exerted by the wastes contained therein.

### SUMMARY OF THE INVENTION

The general object of the present invention is to provide a tank assembly for the collection of human wastes from portable chemical toilets and the periodical maintenance thereof which allow the above mentioned drawbacks of the similar known tanks to be obviated.

A particular object of the present invention is to provide a tank assembly of the above mentioned type wherein the problems associated with its corrosion are solved without sacrificing the mechanical resistance thereof under its normal use conditions.

Another object of the present invention is to provide a tank assembly of the above mentioned type wherein a significant total weight reduction can be accomplished as compared to the conventional tank for similar uses.

Still another object of the invention is to provide a tank truck for the maintenance of portable chemical toilets equipped with a tank assembly for the collection of wastes sucked from a reservoir of a portable chemical toilet of the above mentioned type.

These objects are attained with the tank assembly for the collection of wastes from portable chemical toilets and the periodical maintenance thereof according to the invention the essential features of which are set forth in claim 1. Further important features of the invention are set forth in the dependent claims.

According to an important feature of the invention, the tank assembly is of the type suitable for being fixedly mounted on a tank truck for the collection of waste material from a portable chemical toilet and for the maintenance thereof and comprises a outer rigid housing and an inner tank enclosed in said housing and provided with waste material loading nozzles and waste material discharge nozzles, the outer housing comprising a inner wall having a surface which is complementary and substantially mating and closely contacting the surface of the inner tank. The tank assembly is light-weight and robust, has low production cost and does not exhibit corrosion problems.

According to a preferred embodiment of the invention, the inner tank has a substantially spherical shape.

According to a further preferred embodiment of the invention, the outer rigid housing and the inner tank are made of plastic material.

According to a further preferred embodiment of the invention, the outer rigid housing and the inner tank are made of crosslinked polyethylene.

In a particular embodiment of the invention the outer rigid housing comprises a lower shell fixable to tank assembly transport means and an upper shell fixable to the lower shell at corresponding perimetrical borders thereof.

According to another exemplary embodiment of the invention, the upper shell comprises a wall delimiting therewith a clean water reservoir, the outer surface of the inner wall being substantially in close contact with the wall of an upper portion of the inner tank. The lower shell comprises an inner wall delimiting therewith a detergent liquid reservoir, the outer surface of the inner wall being substantially in close contact with the wall of a lower portion of the inner tank.

### BRIEF DESCRIPTION OF THE DRAWINGS

The above and other features, as well as the and advantages, of the tank assembly for the collection of wastes from portable chemical toilets and for the maintenance thereof according to the present invention will be apparent from the following description of an exemplifying, non-limiting embodiment thereof with reference to the attached drawings, in which:

FIG. 1 is a perspective view of the tank assembly for the collection of wastes from portable chemical toilets and for the maintenance thereof according to the present invention;

FIG. 2 is cross-sectional view of the tank assembly of FIG. 1;

FIG. 3 is a side view of the tank assembly in the direction of arrow F1 in FIG. 1;

FIG. 4 is a side view of the tank assembly in the direction of arrow F2 in FIG. 1;

FIG. 5 is a side view of the tank assembly as opposed to that of FIG. 3;

FIG. 6 is a perspective view of an inner tank of the tank assembly according to the invention;

FIG. 7 is a side view of the inner tank of FIG. 6;

FIG. 8 is a perspective view of a lower shell of the housing of the tank assembly of the invention;

FIG. 9 is a side view of the lower shell in the direction of arrow F3 of FIG. 8;

FIG. 10 is a perspective view of a upper shell of the housing of the tank assembly of the invention;

FIG. 11 is a side view of the upper shell in the direction of arrow F4 of FIG. 10;

FIG. 12 is a plan view taken from the downside of the upper shell of FIG. 10;

FIG. 13 is a top plan view of the upper shell of FIG. 10;

FIG. 14 is a schematic view of a tanker truck on which the tank assembly of the invention is mounted.

### DETAILED DESCRIPTION OF THE INVENTION

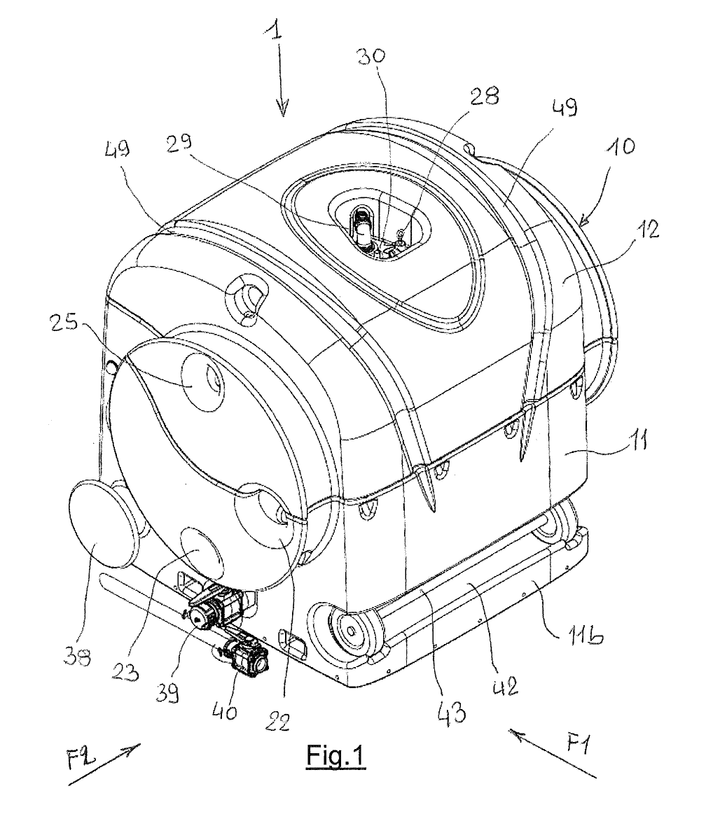

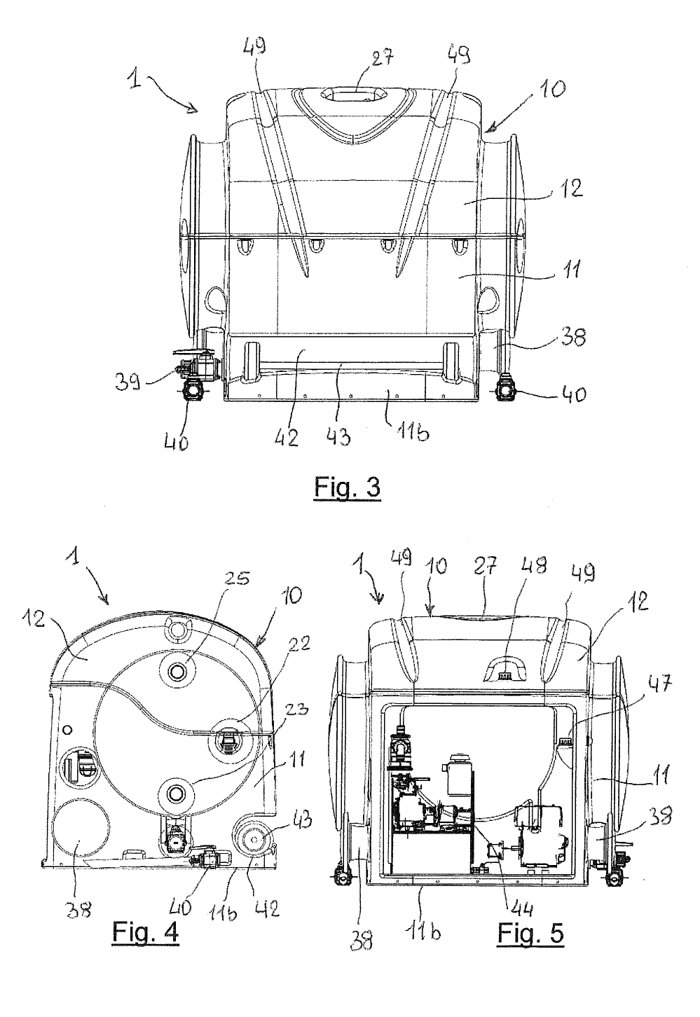

With reference to the FIGS. 1 to 5, it has been generally indicated at 1 a tank assembly comprising a rigid outer housing 10, which in the present embodiment of the invention has a substantially quadrilateral layout and is formed by a lower shell 11 and an upper shell 12, the upper shell 12 being located above the lower shell 11 and joined to each other to define an inner room therebetween generally indicated at 13 in FIG. 3. The two shells 11 and 12 are made of stiff plastic material, for example polyethylene, in particular of the crosslinked type with protection against UV rays.

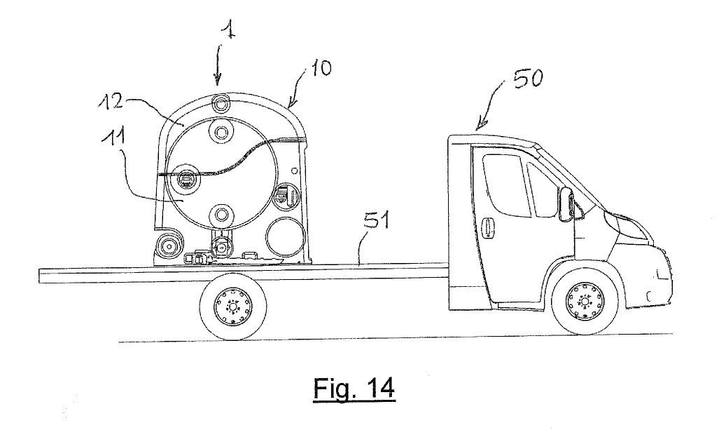

Lower shell 11 has the shape of, substantially, a basin or a tub raising from a base 11b fixable, possibly in a removable way, to the loading bed of a truck, tanker truck or other equivalent vehicle, as shown in FIG. 14.

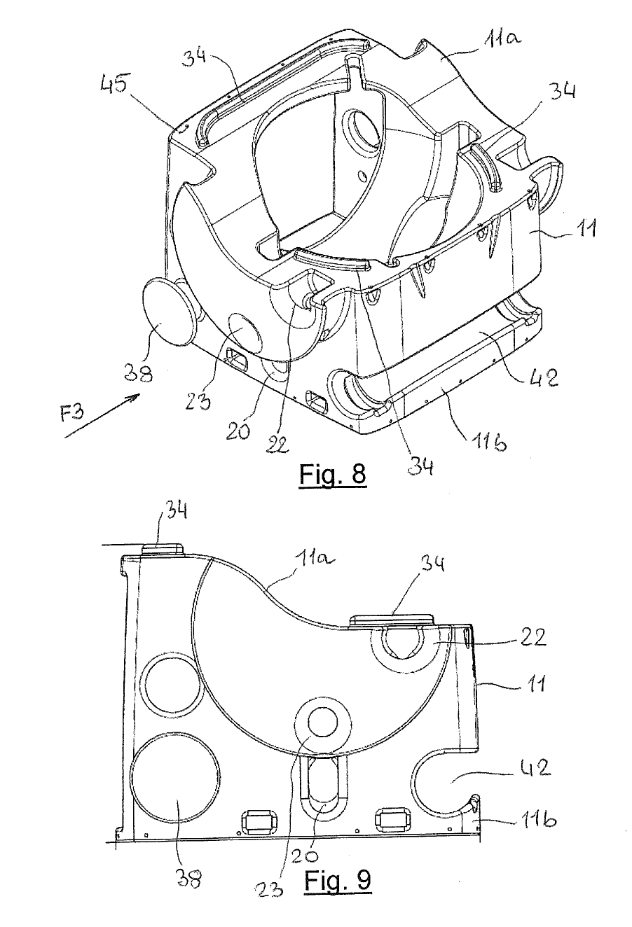

Upper shell 12 has an external shape configured substantially as an half-barrel, in the present embodiment of the invention, and has perimetrical borders 12a resting on corresponding, upwardly facing perimetrical borders 11a of lower shell 11. Upper shell 12 is secured to lower shell 11 along these borders for example by clamp screws, not shown, engaging with corresponding threaded metal inserts shown in FIG. 8, for example, and indicated at 45.

Tank assembly 1 further comprises a substantially spherical inner tank indicated at 14, intended for containing the waste material drained from a portable chemical toilet and arranged in room 13 inside outer housing 10. In particular, a lower portion 14a, or bottom, of inner tank 14 is arranged in lower shell 11 or outer housing 10 and an upper portion 14b, or top, is arranged in upper shell 12 of outer housing 10.

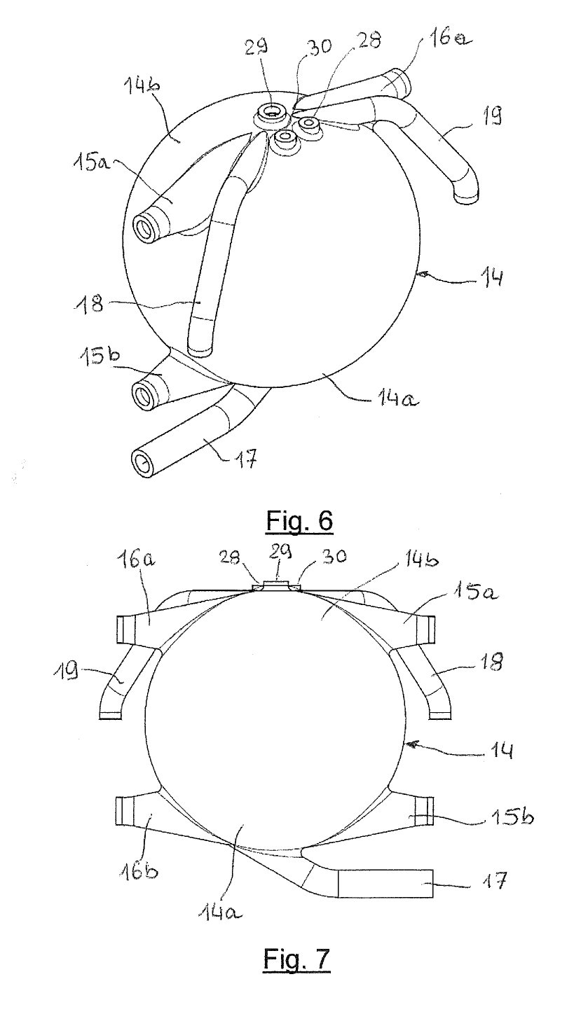

As shown in FIGS. 6 and 7, in the present embodiment inner tank 14 is provided with a waste material discharge nozzle 17 extending from its bottom 14a and a pair of waste material suction nozzles 18 and 19 extending from diametrically opposed parts of its top 14b (a pair of suction nozzles are provided for operating convenience). Furthermore, two pair of inspection nozzles 15a,b and 16a,b, serving as low-level and high-level sight glass, extend on both sides of inner tank 14 in a vertical diametrical plane thereof. Nozzles 15a,b, 16a,b, 17, 18 and 19 protrude from the surface of inner tank 14 to a sufficient extent to emerge with their ends at the outside of outer housing 10 to allow the discharge and suction nozzles to be hydraulically connected to respective discharge and suction conduits and to allow the level of waste material inside inner tank 14 to be controlled from the outside.

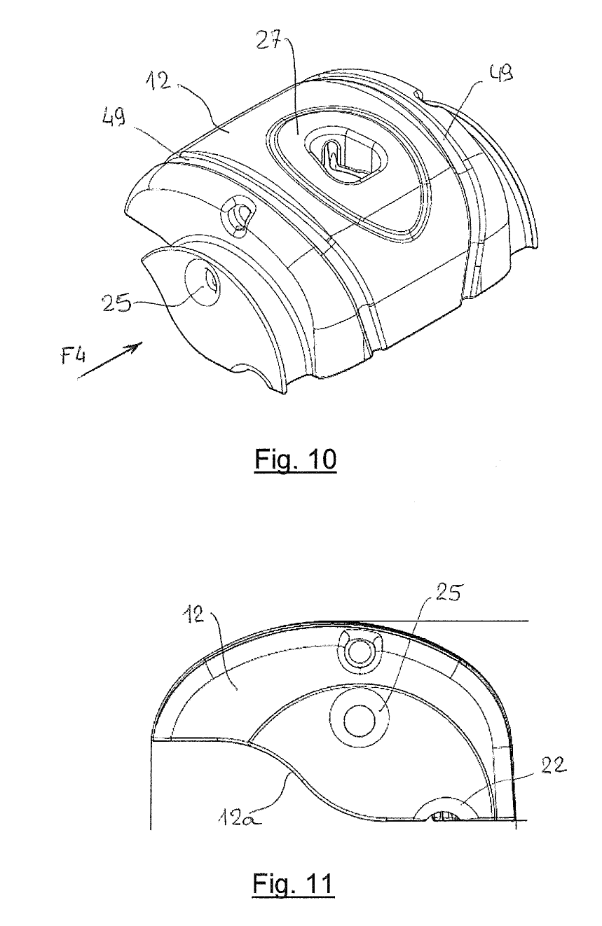

Corresponding openings are formed on outer housing 10 to provide a passage for said nozzles. In particular, as also shown in FIGS. 8 to 13, an opening 20 is formed in the base 11a of lower shell 11 to give access to waste material discharge nozzle 17 and allow a discharge pipe (not shown) to be connected to nozzle 17, in a known way, and a pair of opening 21, 22 is formed on two opposite sides between lower shell 11 and upper shell 12 to give access to waste material suction nozzles 18 and 19 and allow suction pipes (not shown) to be connected to nozzles 18 and 19 in a known way. Two further pair of opening 23, 24 and 25, 26 are formed at diametrically opposed parts of lower shell 11 and, respectively, upper shell 12, and are aligned with inspection nozzles 15b, 16b and 15a, 16a to allow the level of waste liquid in inner tank 14 to be controlled from the outside.

Moreover, at the uppermost part of upper shell 12 an opening 27 is formed defining a seat containing a safety valve 28, an overflow 29 and a vacuum degree regulator 30. In the use, opening 27 will be closed with a lid, not shown.

Inner tank 14 is made of plastic material, for example polyethylene, preferably crosslinked polyethylene, in a single piece complete with the nozzles thereof. Like lower shell 11 and upper shell 12, inner tank 14 is produced by rotational moulding, a technology well known to those skilled in the art and thus not described in detail herein. The inner tank wall thickness may range from 10 to 25 mm; a particularly preferred thickness specifically for inner tank 14 ranges from 12 to 15 mm.

According to an important feature of the present invention, inner tank 14 is housed between two shells 11 and 12 forming outer housing 10 in a not removable way and is tightly enclosed or wrapped between two inner walls 31 and 32 of lower shell 11 and upper shell 12, respectively. Walls 31 and 32 have such a shape complementary to that of the wall of inner tank 14 and, abutting the ones against the other, provide inner tank 14 with a complete support substantially to the entire surface of the tank. In this way, the two walls 31 and 32 provide structural stability to inner tank 14 both when vacuum is applied therein necessary for waste material suction and when it undergoes the internal pressure produced by waste material at full load and the temporary overpressures due to the movement of the vehicle which the tank assembly 1 is mounted, for example on a street bend or in case of a sharp braking. As a result, inner tank 14 is tightly held and kept from moving within the two shells and is not subjected to the risk of deformations due to internal overpressures or underpressures and it is not possible to remove inner tank 14 from room 13 but dismounting outer housing 10 containing it.

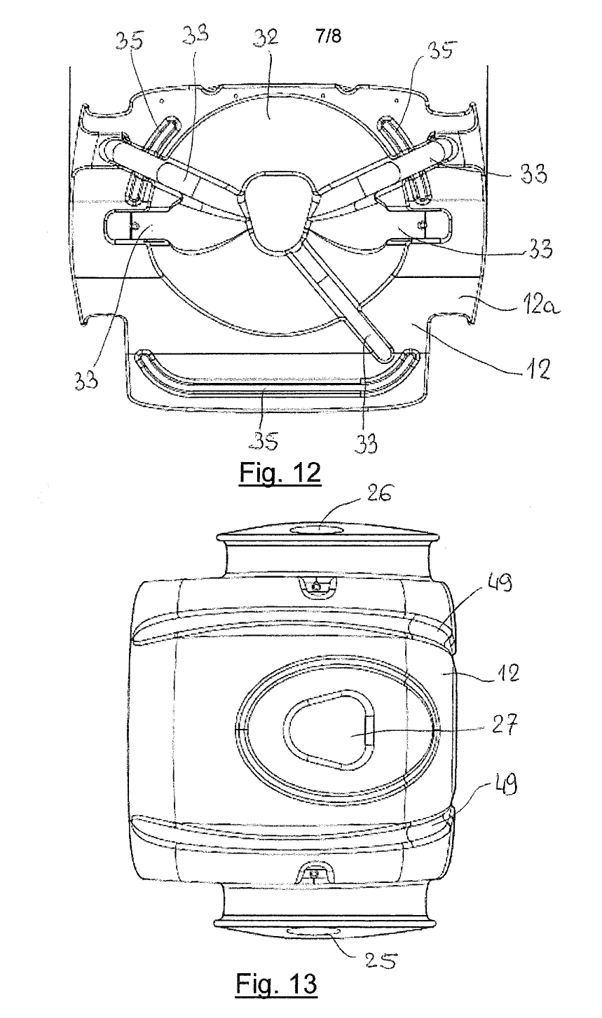

Furthermore, as shown in FIG. 12, shaped cavities 33 are formed on wall 32 of upper shell 12 having such shape and arrangement corresponding to inspection nozzles 15a and 16a and waste material suction nozzles 18 and 19 extending from upper part 14b of inner tank 14, whereby these nozzles engage within said cavities 33 and help to stabilize further the attitude of inner tank 14 in outer housing 10.

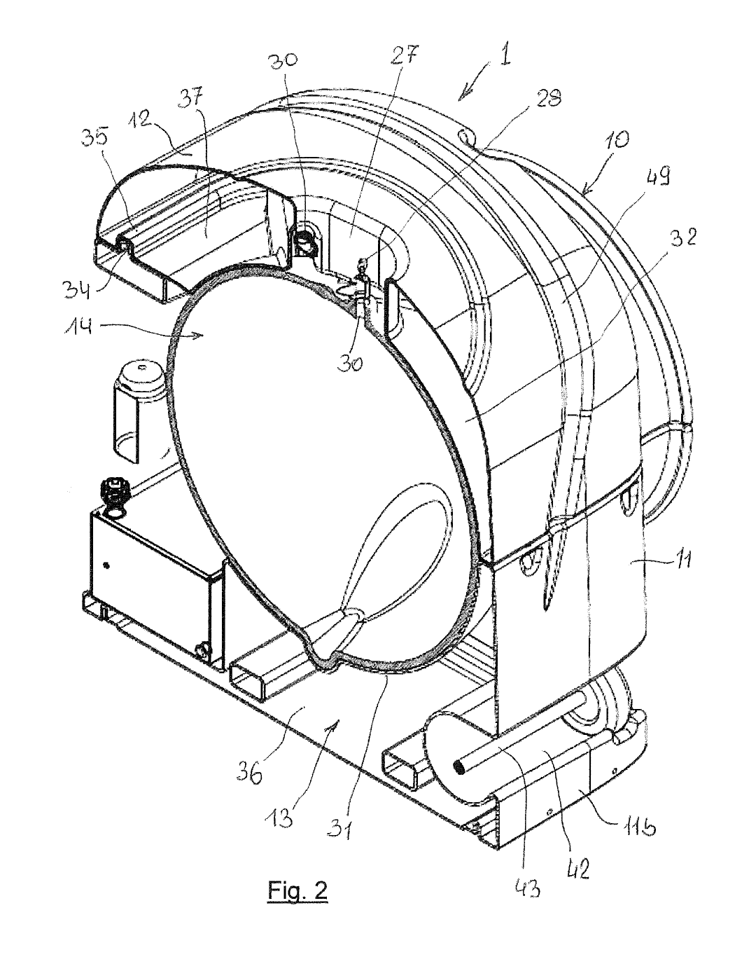

The correct relative positioning of lower shell 11 and upper shell 12 is ensured by ribs 34 protruding from perimetrical border 11a of lower shell 11 and shaped in such way to engage in corresponding grooves 35 formed on mating perimetrical border 12a of upper shell 12, as shown in FIGS. 8 and 12 and, in a mated condition, in FIG. 2.

Inner walls 31 and 32 define, together with the corresponding outer walls of lower shell 11 and upper shell 12, two respective chambers 36 and 37 for containing service liquids, which can be used in particular during maintenance operations of portable chemical toilets, such as a detergent liquid contained in lower chamber 36 and clean water for hand washing, contained in upper chamber 37. Nozzles 47 and 48 are provided to fill in/draw out liquid from chambers 36 and 37, both nozzles being visible in FIG. 5.

Two sleeves 38 on which a cleaning high-pressure hose, not shown, is wound project from two opposite sides of lower shell 11. The hose can be used for drawing out detergent material from chamber 36.

A ball valve 39, or any other equivalent device, is mounted at the end of the waste material discharge nozzle 17 and projects from opening 20 of lower shell 11. When inner tank 14 has to be emptied, a hose will be connected to valve 39 to convey waste material collected therein to a treatment and/or disposal plant.

Waste material is taken out from the portable chemical toilet reservoir by a dip hose 41 with a ball valve 40 (or equivalent) at one end, by which dip hose 41 can be connected to one of the waste material suction nozzles 18 or 19.

At the other two opposite sides of lower shell 11 a first seat 42 is formed for a two-wheeled manual hand truck 43, which can be used when it is necessary to replace, displace or anyway move a cabin of a portable chemical toilet, and a second seat 4 for a vacuum pump 45, to suck waste material from the reservoir of the portable chemical toilet under maintenance to inner tank 14, and a pump 46 for discharging waste material from inner tank 14.

Having made inner tank 14 and relevant outer housing 10, together forming the tank assembly 1 of the present invention, of plastic material allows for a significant weight reduction. For example, in the most common case of a tank assembly of 1000 litres useful volume, empty weight is approximately 800 kg for a prior art tank, while the empty weight of tank assembly 1 according to the present invention is not greater than 350 kg. Moreover, the tank assembly according to the invention also includes a clean water reservoir (i.e. chamber 37), such reservoir being not present with the tanks according to the prior art.

The embodiment herein described and shown provides a inner tank 14 of spherical shape, but it is obvious that a substantially spherical shape, for example having a small eccentricity, i.e. not higher than 30%, preferably not higher than 10%, or wherein two hemi-spherical ends are connected by a short cylindrical length, having a length not greater than 30%, preferably not greater than 10%, of the diameter of each half-sphere, comes within the scope of the present invention.

In order to increase the mechanical stability of outer housing 10 and its resistance to mechanical stresses which undergoes due to acceleration produced by the movements of the vehicle on which the tank assembly 1 is mounted, base 11b of lower shell 11 can be strengthened by a metallic frame fixable to the loading bed of the vehicle. Likewise, metallic angle brackets can be provided at four sides of lower shell 11, possibly fixed to the base metallic frame. Lastly, a pair of transverse metallic bands can be placed within corresponding grooves 49 formed on upper shell 12 fixable to the border of lower shell 11 or to further metallic bands raising from the metallic frame of base 11b of lower shell 11. These construction details are not described nor shown in further detail, as obvious for a person skilled in the art.

A typical application of the tank assembly 1 of the invention is shown in FIG. 14. Tank assembly 1 is mounted on a loading bed 51 of a vehicle generally indicated at 50. Of course, the model of the vehicle shown in FIG. 14 is exemplary only and does not limit in any way the possibility of mounting tank assembly 1 on vehicles of other type, other manufacturer or other loading capacity. Outer housing 10 of tank assembly 1 is fixed to the vehicle frame on the loading bed through its base 11b and tightly encloses inner tank 14, non visible in FIG. 14, which is accessible through the corresponding nozzles only, for the operation of filling with waste material sucked from a reservoir of a portable chemical toilet and/or emptying to a treatment/disposal plant. Thus, inner tank 14 does not require to be removed for outer housing 10 when it has to be emptied, nor outer housing 10 requires to be opened during operation, its essential function being to strictly enclose inner tank 14 to ensure its mechanical stability in any operating condition thereof.

Even if in the present description reference has been made to the use of polyethylene as material for the construction of the outer housing and the inner tank of the tank assembly according to the invention, it is obvious that any other plastic material having equivalent technical features and capable of producing substantially the same effects of the material used herein, can be used as an alternative, as will be obvious to a person skilled in the art.

From the foregoing, it clearly appears that the tank assembly according to the invention fully achieves the prefixed objects, in particular lower production cost, higher duration and lower weight with respect to the prior art waste material tanks of portable chemical toilets. These advantages are made possible by the fact that the tank assembly of the invention is made of a relatively low weight plastic material, that is able to withstand mechanical stresses and atmospheric agents, less costly to produce and free from corrosion problems. The possibility to make the tank assembly of plastic material without sacrificing its mechanical strength under normal operating conditions is due to the fact that the tank assembly is formed by a rigid outer housing and an inner tank of substantially spherical shape contained therein, tightly enclosed between two inner walls of the outer housing having a shape complementary to that of the inner tank and, being in close contact the ones against the other, provide the inner tank with a complete support substantially throughout its whole surface.

Variations and modifications can be made to the tank assembly for collecting waste material from portable chemical toilet and for the periodical maintenance thereof according to the present invention without departing from the scope of the present invention as defined in the appended claims.

1. A tank assembly suitable for being mounted on a tank truck for collection of waste material from a portable chemical toilet and for maintenance of the chemical toilet the tank assembly comprising: an outer rigid housing and an inner tank enclosed in said housing and provided with waste material loading nozzles and waste material discharge nozzles, said outer rigid housing comprising an inner wall having a surface which is complementary and substantially mating and closely contacting a surface of said inner tank, said outer rigid housing and said inner tank being made of plastic material.

2. The tank assembly (1) according to claim 1, wherein said outer rigid housing comprises a lower shell fixable to a tank assembly transport and an upper shell fixable to said lower shell along corresponding perimetrical borders of said upper shell and said lower shell.

3. The tank assembly according to claim 2, wherein said lower shell is substantially tub shaped and said upper shell has a substantially half-barrel outer shape.

4. The tank assembly according to claim 1, wherein said inner tank has a substantially spherical shape.

5. The tank according to claim 2, wherein said lower shell comprises an inner wall, a detergent reservoir being defined between said lower shell and said inner wall of said lower shell, an outer surface of said inner wall substantially mating and closely contacting with a surface of a lower portion of said inner tank.

6. The tank assembly according to claim 2, wherein said upper shell comprises a inner wall, a clean water reservoir being defined between said upper shell and said inner wall of said upper shell, the outer surface of said inner wall substantially mating and closely contacting with a surface of an upper portion of said inner tank.

7. The tank assembly according to claim 1, wherein said outer rigid housing and said inner tank are made of anti-UV cross-linked polyethylene.

8. The tank assembly according to claim 1, wherein said inner tank comprises inspection nozzles for controlling a waste material level in said inner tank.

9. The tank assembly according to claim 1, wherein said outer rigid housing comprises access ports at the waste material discharge nozzles, waste material loading nozzles and waste material level inspection nozzles of said inner tank.

10. The tank assembly according to claim 2, wherein ribs and corresponding grooves are formed along the perimetrical borders of said lower shell and said upper shell for centering said shells when joining said shells to each other.

11. The tank assembly according to claim 1, further comprising a waste material suction system and a system for discharging said waste material at a treatment and/or disposal plant.

12. A tank truck for collection of waste material from portable chemical toilets and for the maintenance of the chemical toilets comprising a loading bed and wherein on said loading bed a tank assembly according to claim 1 is fixedly mounted.
